(19) United States
(12) Patent Application Publication
(10) Pub. No.: US 2019/0195722 A1
(43) Pub. Date: Jun. 27, 2019

(54) Piping Network Leak Detection System, as Well as Leak Detection Device and Leak Detection Method Used in Said System

(71) Applicant: Hitachi Industrial Equipment Systems Co., Ltd., Chiyoda-ku, Tokyo (JP)

(72) Inventors: Yaping LIU, Tokyo (JP); Tatsurou YASHIKI, Tokyo (JP)

(21) Appl. No.: 16/325,490

(22) PCT Filed: Aug. 7, 2017
(86) PCT No.: PCT/JP2017/028605

§ 371 Date: Feb. 14, 2019

(30) Foreign Application Priority Data
Aug. 18, 2016 (JP) 2016-160680

(51) Int. Cl. G01M 3/28; G06F 17/50; G01M 3/18

(52) U.S. Cl. CPC G01M 3/2815; G06F 2217/34; G01M 3/18; G06F 17/5009

(57) ABSTRACT

The purpose of the present invention is to provide a device for detecting leaks in a piping network, said device being capable of performing calculations both at night and on work days without periodic inspections of an entire factory having to be performed on a non-work day, eliminating the need for leak location candidates to be designated, and detecting and outputting the position and amount of leaks of a compressed gas or liquid on the basis of desired time duration measurement values acquired during operation of a compressor. In order to achieve the above purpose, the present invention provides a device for detecting leaks of a compressed gas or liquid in a piping network, wherein the device is characterized in that: time series measurement values are acquired for each of a supply tank pressure and supply tank flow rate supplied from a supply tank and a terminal facility pressure at the entrance of a terminal facility; time series measurement data that exhibits a high change in pressure is extracted; a time series response of the flow rate and pressure within the piping network is calculated on the basis of a piping network model, the extracted time series measurement data being used as a boundary condition in said calculation; the position and amount of a leak of a compressed gas or liquid within the piping network are determined on the basis of the calculated time series response of the flow rate and pressure; and the leak position and leak amount are displayed.

### TECHNICAL FIELD

The present invention relates to a piping network leak detection system detecting and outputting a position where a compressed gas or liquid leaks and the amount of the leakage in a piping network including a device supplying the compressed gas or liquid, piping, and equipment consuming the compressed gas or liquid.

### BACKGROUND ART

A pneumatic system as a piping facility that supplies compressed air to each department in a factory temporarily accumulates the compressed air compressed by an air compressor in an air tank. Subsequently, the system supplies the compressed air from the air tank via a piping path and pneumatic equipment (such as a filter, a dryer, and a control valve) to equipment (terminal facility) consuming the compressed air in a production process in the factory such as an air cylinder and an air blow in the factory. In many cases, compressed air leakage occurs in the piping network during the compressed air supply from the air compressor to the terminal facility through the piping network due to, for example, air piping deterioration attributable to the passage of time and clearances at piping joints and curved parts. It can be said in general statistics that the compressed air leakage is equivalent to approximately 20% to 30% of an air compressor discharge flow rate in a factory without measures against compressed air leakage. Further, similar liquid leakage may occur in a liquid-supplying piping network as well.

Further, in recent years, electric power consumption reduction is required in factories and the like regarding the trend of electric power consumption reduction related to global warming prevention and energy conservation laws. To that end, it is important to grasp a compressed air leak amount and a compressed air leak position and take leakage prevention measures in order to reduce the electric power consumption of an air compressor. In some cases, however, concrete leakage countermeasure implementation is not easy because compressed air leakage is invisible, without smell, or harmless to the human body and the environment.

According to conventional compressed air leakage countermeasures, an air compressor needs to be operated on a day when no factory production is conducted such as a non-work day and a leak amount needs to be calculated on the basis of a value measured by a flow meter or an electric power meter attached to a terminal facility so that the occurrence or nonoccurrence of compressed air leakage can be confirmed. Actual leak position grasping is quite burdensome on a worker's part as the air compressor should be operated on a non-production day as described above, he or she should look around the factory, and ultrasonic waves with a frequency of around 40 KHz should be detected with an ultrasonic leak detector or the like. In addition, periodic confirmation and repair are necessary as compressed air leaks from air piping joints and so on in many cases and leakage may be repeated over time after fixing due to deterioration, looseness, or the like.

The background art pertaining to this technical field includes JP 2011-54209 A (Patent Document 1). A compressed air leakage diagnosis technique is disclosed in Patent Document 1. According to Patent Document 1, a user inputs a compressed air leak position candidate in a network and solves an optimization problem to minimize an objective function to be defined by using network values calculated and measured by a piping network simulation device. In this manner, the user performs compressed air leak location candidate and leak amount calculations.

### CITATION LIST

### Patent Document

Patent Document 1: JP 2011-54209 A

### SUMMARY OF THE INVENTION

### Problems to be Solved by the Invention

As described above, in Patent Document 1, a compressed air leak position candidate is input beforehand in a piping network defined as virtual compressed air consumption equipment configured from pneumatic equipment and compressed air leakage. In addition, the steady state of the entire piping network at a certain time is calculated with respect to every combination of designated compressed air leakage locations and the optimization problem described above is solved for the purpose of compressed air leak position determination.

Indispensable for the technique described in Patent Document 1 is for the user to pre-input compressed air leak location candidates, and a highly likely candidate is output from the input compressed air leak location candidates. In other words, whether leakage actually occurs is diagnosed with respect to the compressed air leak location candidates, and thus a location not designated as a leak location candidate is not included in the leak locations and omission may occur during the leak location detection. Besides, optimization calculation needs to be conducted with respect to every compressed air leak location combination and a problem arises from an enormous amount of calculation processing as for a large-scale piping network.

The technique described in Patent Document 1 provides no specific description at all with regard to measured values pertaining to a piping network. In other words, nothing is described in Patent Document 1 regarding, for example, locations and numbers required for measurement. Optimization calculation results are highly dependent on selection of the measured values, and thus a problem arises as no precision of detection is guaranteed concerning compressed air leak locations and amounts.

The present invention has been made in view of the above circumstances, and the purpose of the present invention is to provide a piping network leak detection system and a leak detection device and a leak detection method used in the system capable of detecting and outputting the position and amount of leaks of a compressed gas or liquid on the basis of desired time duration measurement values acquired during operation of a compressor and eliminating the need for leak location candidates to be designated in a piping network.

### Solutions to Problems

In order to achieve the above purpose, the present invention has the following configuration as an example. A device for detecting leaks of a gas or liquid in a piping network temporarily accumulates a compressed gas or liquid compressed by a compressor in a supply tank and then supplies the compressed gas or liquid from the supply tank via piping to a terminal facility consuming the compressed gas or liquid. The leak detection device includes a time series measurement value acquisition unit acquiring a time series measurement value for each of a supply tank pressure and supply tank flow rate supplied from the gas or liquid supply tank and a terminal facility pressure at an entrance of the terminal facility, a time series measurement data extraction unit extracting time series measurement data exhibiting a high change in pressure for a certain time duration from the time series measurement value, a piping network model construction unit creating a piping network model including the compressor, the supply tank, the terminal facility, and the piping, a time series response calculation unit calculating a time series response of a flow rate and pressure within the piping network on the basis of the piping network model, the extracted time series measurement data being used as a boundary condition in the calculation, a leak position/amount determination unit determining the position and amount of a leak of the gas or liquid within the piping network on the basis of the calculated time series response of the flow rate and pressure, and an output display unit displaying the leak position and leak amount.

### Effects of the Invention

According to the present invention, it is possible to provide a piping network leak detection system and a leak detection device and a leak detection method used in the system with which conventionally required periodic inspections are unnecessary. The system uses time series measurement values acquired during compressor operation, and thus high-precision leak detection can be performed.

### BRIEF DESCRIPTION OF THE DRAWINGS

FIG. 1 is a block diagram illustrating the configuration of a piping network leak detection system according to a first example.

FIG. 2 is an explanatory diagram illustrating a specific example of a time series measurement value acquired from each sensor according to the first example.

FIG. 3 is a specific example of terminal facility pressure time series measurement data according to the first example.

FIG. 4 is a specific example of the terminal facility pressure time series measurement data according to the first example.

FIG. 5 is an explanatory diagram illustrating an input screen of the piping network leak detection system according to the first example.

FIG. 6 is an explanatory diagram illustrating an output screen of the piping network leak detection system according to the first example.

FIG. 7 is a flowchart illustrating calculation processing for leak position/amount determination in the piping network leak detection system according to the first example.

FIG. 8 is an explanatory diagram illustrating an output screen of a piping network leak detection system according to a second example.

FIG. 9 is an explanatory diagram illustrating another output screen of the piping network leak detection system according to the second example and is an explanatory diagram illustrating an output specific example.

### MODE FOR CARRYING OUT THE INVENTION

Hereinafter, examples of the present invention will be described with reference to accompanying drawings.

### First Example

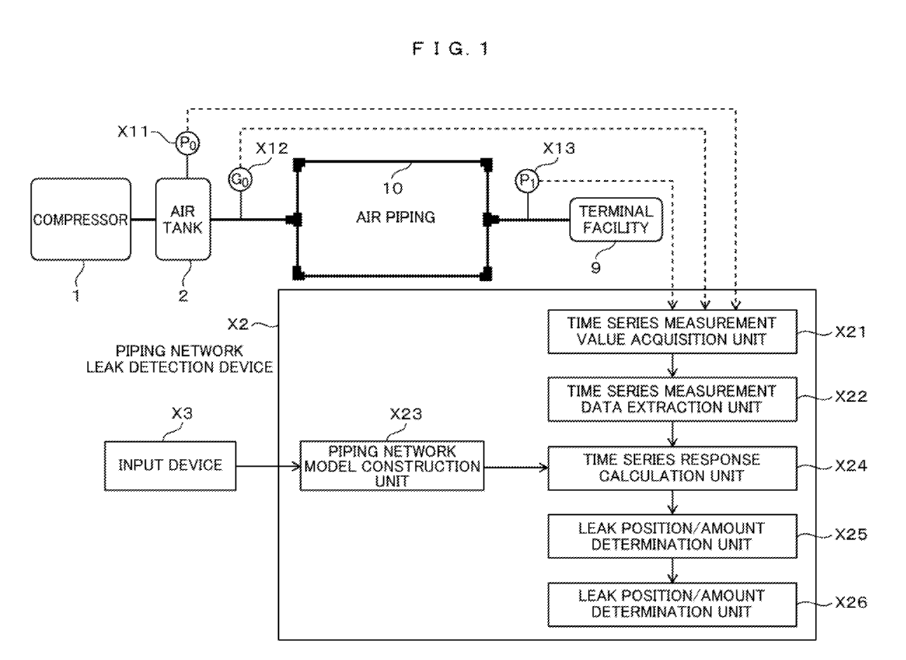

FIG. 1 is a block diagram illustrating the configuration of a piping network leak detection system according to the present example.

The piping network leak detection system illustrated in FIG. 1 is provided with pressure sensors X11 and X13, a flow rate sensor X12, a piping network leak detection device X2, and an input device X3. A pneumatic system as a target of the piping network leak detection system is a piping facility that temporarily accumulates compressed air compressed by a compressor 1 in an air tank 2 and then supplies the compressed air from the air tank 2 via a joint or air piping 10 to a compressed air-consuming terminal facility 9 such as an air cylinder and an air blow.

In FIG. 1, the pressure sensor X11 detects the pressure of the compressed air supplied from the air tank 2. The sensor may be installed in the air tank 2 or at the exit of the air tank 2. The flow rate sensor X12 detects the flow rate of the compressed air supplied from the air tank 2. The pressure sensor X13 detects the pressure of the entrance of the terminal facility 9. The dotted lines in FIG. 1 indicate data and signal flows. The detection values of the pressure sensors X11 and X13 and the flow rate sensor X12 are input to the piping network leak detection device X2.

The piping network leak detection device X2 calculates the internal pressure and flow rate of a piping network by using the detection values of the pressure sensors X11 and X13 and the flow rate sensor X12 as inputs, detects a leak position and the leak amount at the leak position, and displays the result of the detection on a display device. It should be noted that these processes are executed by software processing.

The piping network leak detection device X2 includes a time series measurement value acquisition unit X21, a time series measurement data extraction unit X22, a piping network model construction unit X23, a time series response calculation unit X24, a leak position/amount determination unit X25, and an output display unit X26. A schematic configuration of the piping network leak detection device X2 will be described below.

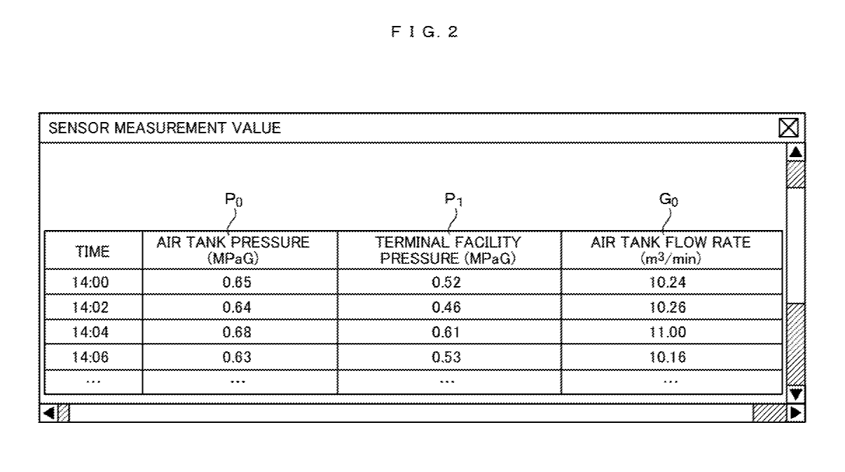

The time series measurement value acquisition unit X21 acquires and stores air tank pressure measurement data P₀ detected from the pressure sensor X11, air tank exit flow rate measurement data G₀ detected from the flow rate sensor X12, and terminal facility entrance pressure measurement data P₁ detected from the pressure sensor X13. FIG. 2 illustrates a specific example of storage of the time series measurement values acquired at a sampling time of 2 seconds from the respective sensors. This data may be output on an output screen provided in the piping network leak detection system or the piping network leak detection device.

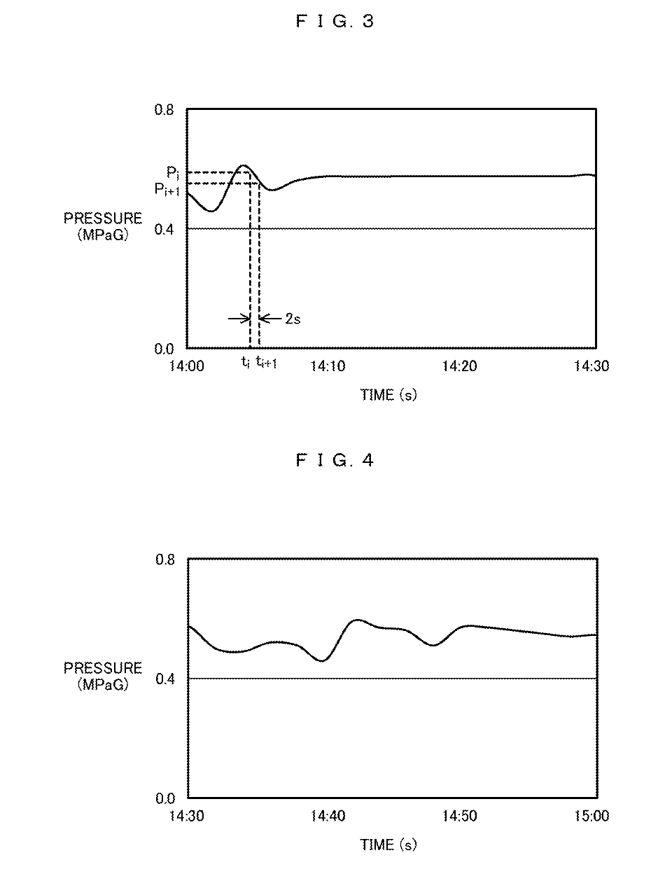

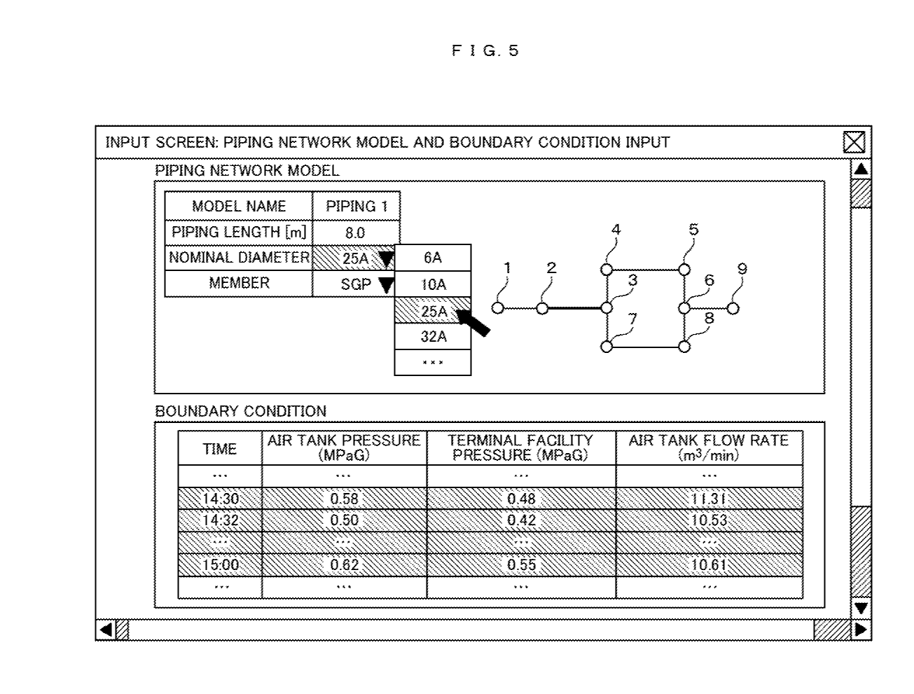

The time series measurement data extraction unit X22 extracts measurement data of a certain time duration from the time series measurement value acquired by the time series measurement value acquisition unit X21. The extracted measurement data is a boundary condition of the time series response calculation of the intra-piping network pressure and flow rate in the time series response calculation unit X24. Here, in the present example, repeated calculation is required for the leak position and leak amount determination. Accordingly, the measurement data of a time duration that exhibits a high change is preferentially extracted so that the leak position and the leak amount are detected with high precision and in a short calculation time. Specific examples of the time series measurement data extraction unit according to the present example will be described below with reference to FIGS. 3 and 4.

FIGS. 3 and 4 are specific examples of the time series measurement data with respect to the 30 seconds of time 14:00 to 14:30 and the 30 seconds of time 14:30 to 15:00 in the terminal facility pressure time series measurement values stored in FIG. 2. Comparing the data in FIG. 3 and the data in FIG. 4 to each other, the time duration of 14:30 to 15:00 in FIG. 4 exhibits a higher change in pressure and thus is extracted and stored as a terminal facility entrance pressure boundary condition P₁¹. Here, the amount of change in measurement value with respect to each time duration is calculated by the change in measurement value with respect to a sampling time interval being added as in, for example, Equation (1).

Σ^{N}ᵢ₌₁|Xᵢ−Xᵢ₊₁| (1)

In Equation (1), Xᵢ is a measurement value with respect to time tᵢ, Xᵢ₊₁ is a measurement value with respect to time tᵢ₊₁, and N is the number of sampling points with respect to an evaluation time duration. In the examples illustrated in FIGS. 3 and 4, Xᵢ and Xᵢ₊₁ are pressures and the number of sampling points is 16.

Next, the air tank exit pressure time series measurement data with respect to the extraction time duration of 14:30 to 15:00 is extracted and stored as an air tank exit pressure boundary condition P₀¹. Likewise, the air tank flow rate time series measurement data with respect to 14:30 to 15:00 is extracted and stored as G₀¹. In the present example, the amount of change with respect to each time duration is calculated on the basis of Equation (1) from the time series measurement data and the measurement data of the time duration exhibiting a high change is automatically extracted and stored as the boundary condition, and thus no human work is required.

The piping network model construction unit X23 constructs a network simulation model expressing the joint and a pneumatic device such as the compressor, the terminal facility, and the air tank as nodes and expressing the air piping as a line via the input device X3. The input screen of the piping network leak detection system will be described below with reference to FIG. 5.

As illustrated in FIG. 5, a specific example of piping network model input is shown on the upper left side of the display screen of a piping network simulation device. A piping length, a nominal diameter, and the set value of a member as the equipment attributes of the piping are displayed in FIG. 5. A value is input for the piping length and the nominal diameter and the member are selected from the contents displayed in the pull-down menus. Illustrated in FIG. 5 is a state where the nominal diameter is selected in the pull-down menu. In addition, shown on the upper right side of the display screen is an example in which the piping network is input as nodes and a line. In this example, branches 3 and 6 as piping branch points and elbows 4, 5, 7, and 8 as bent piping parts are shown as the air piping 10 with respect to the compressor 1, the air tank 2, and the terminal facility 9. Further, on the lower side of the display screen of the piping network simulation device, the pressure boundary condition and the air tank flow rate time series measurement data of the air tank and the terminal facility extracted by the time series measurement data extraction unit X22 are highlighted by coloring.

On the basis of the piping network model, the time series response calculation unit X24 calculates a time series response of the intra-piping network pressure and flow rate with respect to the air tank exit pressure boundary condition P₀¹ and the terminal facility entrance pressure boundary condition P₁¹ extracted by the time series measurement data extraction unit X22 in view of the friction and heat losses of the pneumatic device and the piping.

The leak position/amount determination unit X25 determines the compressed air leak position/amount on the basis of the time series response of the intra-piping network pressure and flow rate calculated by the time series measurement data extraction unit X22. Specifically, the leak position/amount determination unit X25 solves the problem of minimizing the difference between the air tank exit flow rate time series measurement data G₀¹ and air tank exit flow rate time series calculation data G₀¹ by the intra-piping network time series response calculation by using the leak amount as an unknown parameter. Here, it is assumed that the compressed air leaks at the terminal facility, a valve, the joint for piping connection, and the like and the leak position is limited to the nodes on the piping network model.

The output display unit X26 displays the leak position on the piping network model. Also, a loss cost is calculated from the leak amount at the leak position. It should be noted that the output unit of the output display unit X26 may be provided in the piping network leak detection device with the display unit provided with an output screen separate from the device for display on the output screen.

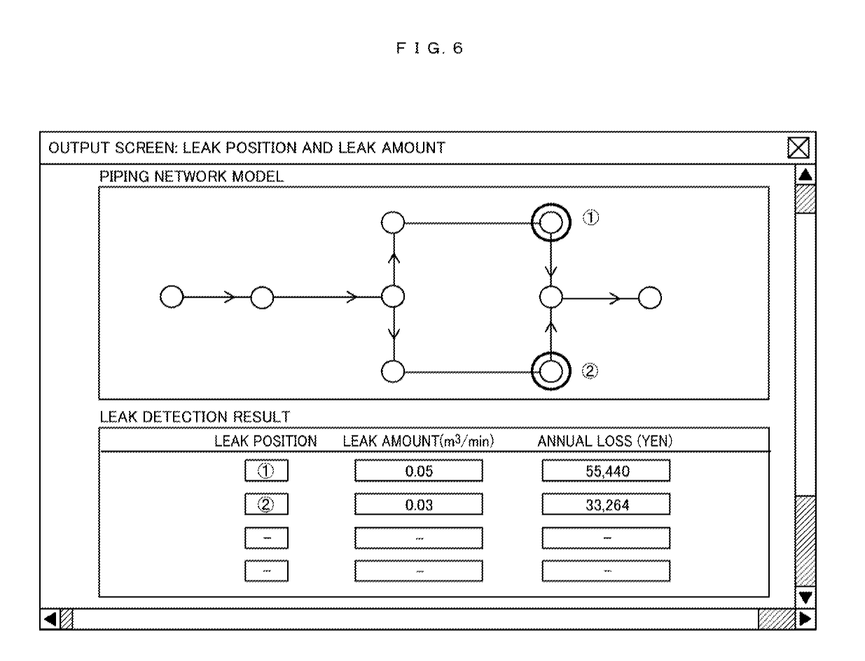

FIG. 6 is the output screen of the piping network simulation device and an example of the display by the output display unit. Illustrated in FIG. 6 is an example in which the direction in which the compressed air flows is indicated by arrows with respect to the piping on the piping network model. In addition, leak positions are highlighted with double circles and each detected leak position is numbered. The leak amount and the annual loss at each detected leak position are displayed as leak detection results at the lower part of the display screen of the piping network simulation device.

In the example that is illustrated in FIG. 6, the leak amount and the annual loss cost of the detected leak position (1) are 0.05 m³/min and 55,440 yen, respectively. Here, the annual loss cost is calculated from the operation time and the unit price of the compressed air. In the example with respect to the leak position (1), an annual operation time of 8,400 hours results in an annual leakage of 25,200 m³ and the annual loss cost is 55,440 yen when the unit price of the compressed air is 2.2 yen/m³. The leak amount and the annual loss cost of the leak position (2) are 0.03 m³/min and 33,264 yen, respectively.

The schematic configuration of the piping network leak detection device X2 has been described above.

The input device X3 is provided with a keyboard, a mouse, and the like and constructs the network simulation model.

A schematic configuration of the piping network leak detection system has been described above.

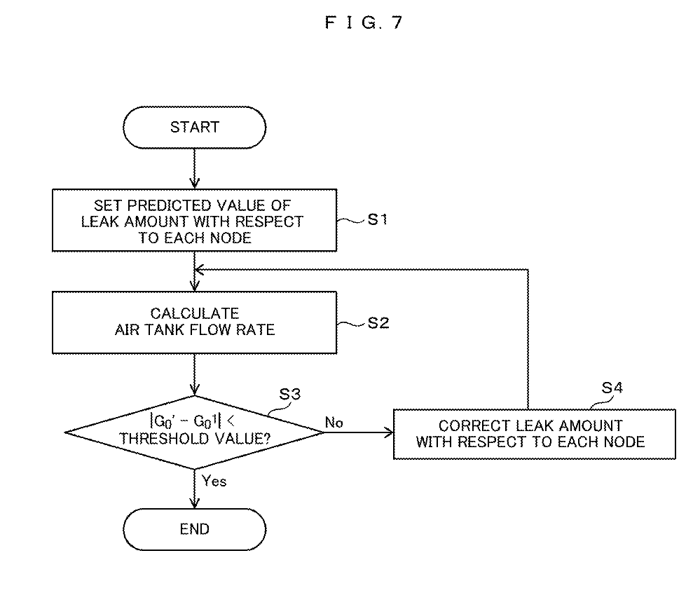

Next, the flow of calculation processing for the leak position/amount determination according to the present example will be described with reference to FIG. 7. In FIG. 7, substitution with a predicted leak amount value with respect to each node of the piping network model is performed as Step S1 (node-specific leak amount prediction step). Substitution with zero is performed in a case where a zero-leakage determination is possible.

As Step S2 (air tank flow rate calculation step), the air tank exit flow rate time series calculation data G₀′ is calculated by the time series response of the intra-piping network pressure and flow rate being calculated by piping network model information, the air tank exit pressure time series measurement data P₀¹, and the terminal facility entrance pressure time series measurement data P₁¹ being used as boundary conditions.

As Step S3 (air tank flow rate calculation data and flow rate measurement data confirmation step), a difference ΔG between the air tank exit flow rate time series measurement data G₀¹ and the air tank exit flow rate time series calculation data G₀′ calculated in Step S2 is calculated and it is determined whether or not the difference value falls within a certain threshold value. The processing is terminated when the determination result is Yes. The processing proceeds to Step S4 (node-specific leak amount correction step) when the determination result is No. Here, ΔG is calculated from the following Equation (2).

ΔG=∫|G₀′−G₀¹|dt (2)

As Step S4 (node-specific leak amount correction step), the node-specific leak amount predicted in Step S1 is corrected by a known optimization calculation method such that the objective function calculated from Equation (2) is minimized. Then, the processing returns to Step S2.

The flow of the calculation processing for the intra-piping network leak position/amount determination has been described above.

In the present example, X21 (time series measurement value acquisition unit) is capable of performing calculations for leak position/amount determination both at night and on work days without requiring periodic inspections of an entire factory conventionally required for leakage position grasping. Accordingly, leak position/amount determination can be performed without manual work.

In X22 (time series measurement data extraction unit), X24 (time series response calculation unit), and X25 (leak position/amount determination unit), the time series response of the flow rate and pressure within the piping network is calculated on the basis of the measurement data of a time duration exhibiting a high change during operation of the air compressor and the compressed air leak position/amount are determined by the leak amount being corrected such that the time series measurement value and the time series response calculation value coincide with each other. Accordingly, it is possible to obtain a highly accurate leak information-related detection result and prompt measures can be taken against compressed air leakage.

In addition, no leak location candidate designation is necessary in the piping network, a detected leak position is displayed with respect to the piping network model on the output screen in X23 (piping network model construction unit) and X26 (output display unit), and a leak point can be quickly identified. Further, it is possible to output an annual loss result based on the leak amount and confirm an economic effect.

As described above, in the present example, conventionally required periodic inspections are unnecessary and the time series measurement value acquired during compressor operation is used. Accordingly, it is possible to provide a piping network leak detection system along with a leak detection device and a leak detection method used in the high-accuracy leak detection system.

### Second Example

Described below is an example of the piping network leak detection system that is capable of extracting the time series measurement data more than once, performing leak detection, and confirming the history and the result of the detection.

Omitted is a block diagram illustrating the configuration of the piping network leak detection system according to the present example, which is almost identical to FIG. 1 for the first example. The present example differs from FIG. 1 in that the output display unit X26 in FIG. 1 detects leak positions and leak amounts more than once with respect to different time durations in displaying leak detection results.

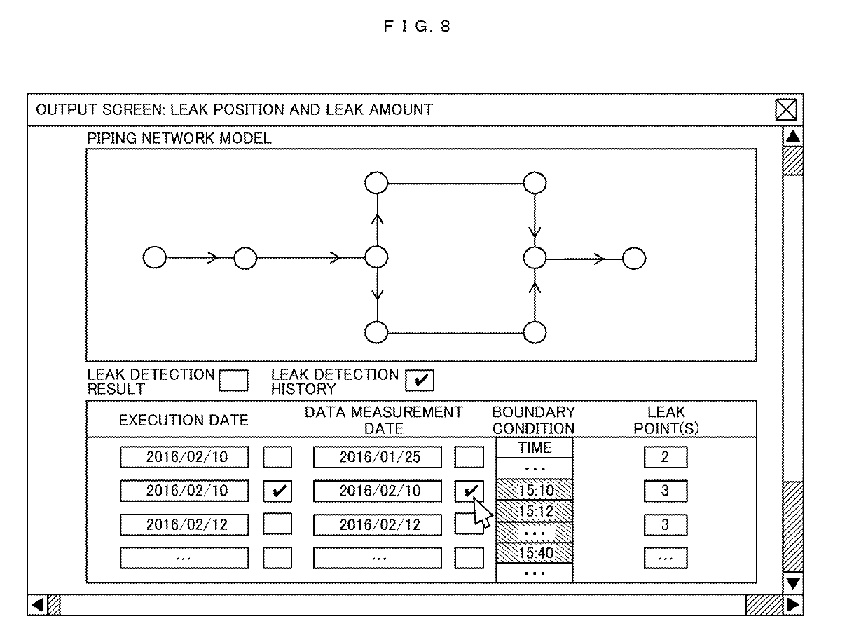

A specific example of the output screen according to the present example is illustrated in FIG. 8, which differs from the specific example of the output screen according to the first example illustrated in FIG. 6 in that a leak detection history item is installed in addition to the leak detection result. In FIG. 8, an execution date, a data measurement date, and a leak point are displayed, as the leak detection history, at the lower part of the display screen of the piping network simulation device once the leak detection history button is checked. Further, detailed data of the boundary condition used for leak detection can be confirmed once the data measurement date button is checked.

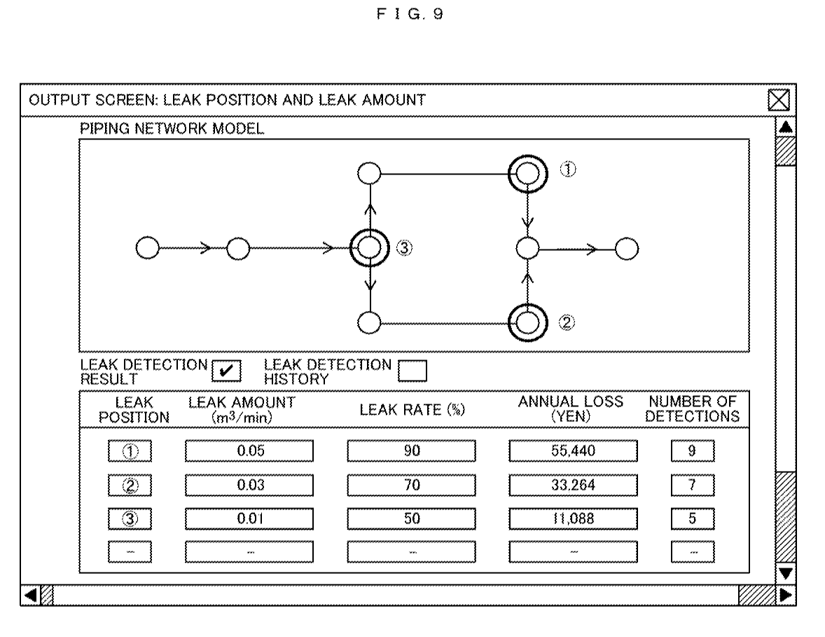

Illustrated in FIG. 9 are leak detection results pertaining to an execution date checked on the output screen illustrated in FIG. 8. The specific example that is illustrated in FIG. 9 differs from the specific example of the output screen according to the first example in FIG. 6 in that a leak rate and the number of detections are installed as results. The leak rate calculates the probability of leakage at a leakage position from the number of detections in the entire detection history.

In the present example, leak position/amount detection is performed more than once with respect to different time durations, and leak rates are calculated with respect to leak positions as a result. Accordingly, high-precision leak position/amount detection can be achieved along with each effect of the first example. In addition, leak points can be sequentially improved in accordance with the leak rates. Further, new measurement data-based periodic and automatic detection is possible for points where leakage may be repeated over time after fixing due to deterioration, looseness, or the like.

Although examples have been described above, the present invention is not limited to the examples described above. The present invention includes various modification examples. For instance, the air compressor in the description of the examples can be replaced with compressors for general gases and liquids. Conceivable as the compressors in that case are a gas-sending air compressor or blower, a liquid-sending pump, and the like. In other words, the air in the examples described above may be replaced with a gas or a liquid. In addition, the air tank in the examples described above may be a gas tank or a liquid tank and the tanks may be collectively referred to as supply tanks.

### REFERENCE SIGNS LIST

1 Compressor
2 Air tank
3, 6 Branch
4, 5, 7, 8 Elbow
9 Terminal facility
10 Air piping
X11, X13 Pressure sensor
X12 Flow rate sensor
X2 Piping network leak detection device
X21 Time series measurement value acquisition unit
X22 Time series measurement data extraction unit
X23 Piping network model construction unit
X24 Time series response calculation unit
X25 Leak position/amount determination unit
X26 Output display unit
X3 Input device
S1 Node-specific leak amount prediction step
S2 Air tank flow rate calculation step
S3 Air tank flow rate calculation data and flow rate measurement data confirmation step
S4 Node-specific leak amount correction step

1. A device for detecting leaks of a gas or liquid in a piping network, the device temporarily accumulating a compressed gas or liquid compressed by a compressor in a supply tank and then supplying the compressed gas or liquid from the supply tank via piping to a terminal facility consuming the compressed gas or liquid, the leak detection device comprising:
a time series measurement value acquisition unit acquiring a time series measurement value for each of a supply tank pressure and supply tank flow rate supplied from the gas or liquid supply tank and a terminal facility pressure at an entrance of the terminal facility;
a time series measurement data extraction unit extracting time series measurement data exhibiting a high change in pressure for a certain time duration from the time series measurement value;
a piping network model construction unit creating a piping network model including the compressor, the supply tank, the terminal facility, and the piping;
a time series response calculation unit calculating a time series response of a flow rate and pressure within the piping network on the basis of the piping network model, the extracted time series measurement data being used as a boundary condition in the calculation;
a leak position/amount determination unit determining the position and amount of a leak of the gas or liquid within the piping network on the basis of the calculated time series response of the flow rate and pressure; and
an output display unit displaying the leak position and leak amount.

2. The leak detection device according to claim 1, wherein the leak position/amount determination unit corrects the leak amount by solving a problem so as to minimize a difference between time series measurement data of the supply tank flow rate by the time series measurement data extraction unit and time series calculation data of the supply tank flow rate by the time series response calculation unit by using the leak amount as an unknown parameter.

3. The leak detection device according to claim 1, wherein the output display unit displays a direction in which the compressed gas flows, the leak position, the leak amount, and an annual loss.

4. The leak detection device according to claim 1, wherein the time series measurement data is extracted more than once by the time series measurement data extraction unit, the leak detection is executed more than once by the leak position/amount determination unit, and the output display unit displays a history and result of the leak detection.

5. The leak detection device according to claim 4, wherein the output display unit displays an execution date, a data measurement date, a boundary condition, and a leak point in the leak detection history.

6. The leak detection device according to claim 4, wherein the output display unit displays a leak rate and the number of detections.

7. A piping network leak detection system for detecting leaks of a gas or liquid flowing through piping in a piping network, the system temporarily accumulating a compressed gas or liquid compressed by a compressor in a supply tank and then supplying the compressed gas or liquid from the supply tank via the piping to a terminal facility consuming the compressed gas or liquid, the piping network leak detection system comprising:
a supply tank pressure sensor detecting a pressure of the compressed gas or liquid supplied from the supply tank;
a supply tank flow rate sensor detecting a flow rate of the gas or liquid from the supply tank;
a terminal facility pressure sensor detecting a pressure at an entrance of the terminal facility;
a piping network leak detection device; and
a display device,
wherein the piping network leak detection device includes:
a time series measurement value acquisition unit acquiring and storing a time series measurement value of each pressure sensor and flow rate sensor pertaining to a time duration during operation of the compressor from the supply tank pressure sensor, the supply tank flow rate sensor, and the terminal facility pressure sensor;
a time series measurement data extraction unit extracting time series measurement data exhibiting a high rate of change within a certain time duration from the acquired time series measurement value;
a piping network model construction unit creating a piping network model including the compressor, the supply tank, the terminal facility, and the piping;
a time series response calculation unit calculating a time series response of a flow rate and pressure on the basis of the piping network model, the extracted time series measurement data being used as a boundary condition in the calculation;
a leak position/amount determination unit detecting the position and amount of a leak within the piping network on the basis of the calculated time series response; and
an output display unit sending the leak position and leak amount to the display device.

8. The piping network leak detection system according to claim 7, wherein the output display unit transmits a direction in which the compressed gas or liquid flows, the leak position, the leak amount, and an annual loss to the display device and the display device displays the received information.

9. The piping network leak detection system according to claim 7, wherein the time series measurement data is extracted more than once by the time series measurement data extraction unit, the leak detection is executed more than once by the leak position/amount determination unit, the output display unit transmits a history and result of the leak detection to the display device, and the display device displays the received information.

10. The piping network leak detection system according to claim 9, wherein the output display unit transmits an execution date, a data measurement date, a boundary condition, and a leak point in the leak detection history to the display device and the display device displays the received information.

11. The piping network leak detection system according to claim 9, wherein the output display unit transmits a leak rate and the number of detections to the display device and the display device displays the received information.

12. A leak detection method for a compressed gas or liquid in a piping network, the compressed gas or liquid compressed by a compressor being temporarily accumulated in a supply tank and then supplied from the supply tank via piping to a terminal facility consuming the compressed gas or liquid, the leak detection method comprising:
constructing a piping network model including the compressor, the supply tank, the terminal facility, and the piping;
acquiring a time series measurement value for each of a supply tank pressure and supply tank flow rate supplied from the supply tank and a terminal facility pressure at an entrance of the terminal facility;
calculating a time series response of the flow rate and pressure within the piping network on the basis of the piping network model, using the time series measurement value; and
determining and displaying the position and amount of a leak of the gas or liquid within the piping network on the basis of the calculated time series response of the flow rate and pressure.

13. The leak detection method according to claim 12, wherein time series calculation data is generated by time series measurement data exhibiting a high change in pressure for a certain time duration being extracted from the time series measurement value and the time series response of the flow rate and pressure within the piping network being calculated with the extracted time series measurement data as a boundary condition.

14. The leak detection method according to claim 13, wherein the leak amount determination is performed by the leak amount as an unknown parameter being corrected by a problem being solved such that a difference between time series measurement data of the supply tank flow rate and time series calculation data of the supply tank flow rate is minimized.
